(19) United States
(12) Patent Application Publication
(10) Pub. No.: US 2012/0297102 A1
(43) Pub. Date: Nov. 22, 2012

(54) SERVER AND MOTHERBOARD

(75) Inventors: BO TIAN, Shenzhen City (CN); KANG WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/176,813

(22) Filed: Jul. 6, 2011

(30) Foreign Application Priority Data
May 20, 2011 (CN) 201110131177.1

(51) Int. Cl. G06F 13/00

(52) U.S. Cl. 710/300

(57) ABSTRACT

A server includes a motherboard and a fan system. The motherboard includes a circuit board, on which are mounted a first and a second groups of expansion slots, a central processing unit (CPU) and a group of memory slots. The fan system is arranged near a side of the circuit board, and the disposition of the fan system and the components on the circuit board is such that the airflow from the fan system does not blow pre-heated air from one component over a second component.

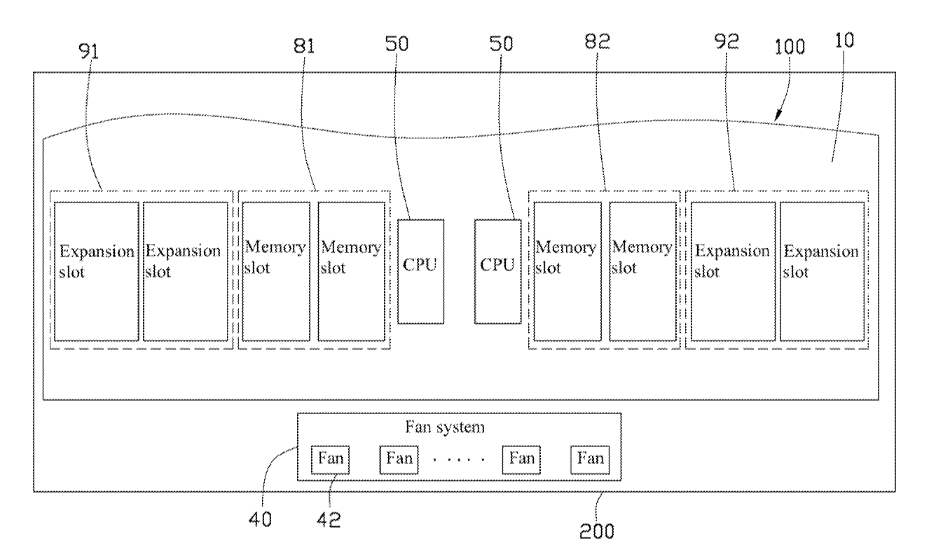

### BACKGROUND

1. Technical Field

The present disclosure relates to a server and a motherboard of the server.

2. Description of Related Art

Generally, a fan system is often mounted near a first side of a motherboard in a server, while expansion slots for Peripheral Component Interconnect Express (PCIe) cards are arranged on a second side of the motherboard opposite to the fan system. Airflow from the fan system flows through and across the central processing units and memory chips. The heated airflow then flows through and across the PCIE cards, which may cause the chips mounted on the PCIE cards to work unreliably, erratically or less than optimally.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The figure is a schematic diagram of an exemplary embodiment of a server.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the figure, an exemplary embodiment of a server 200 includes a motherboard 100, and a fan system 40 comprising a plurality of fans 42 arranged in a row. The motherboard 100 includes a circuit board 10, two central processing units (CPUs) 50 arranged next to each other at or around the center of the circuit board 10, a first group of memory slots 81 and a second group of memory slots 82 arranged on the side of the circuit board 10 and flanking the two CPUs 50, and a first group of expansion slots 91 and a second group of expansion slots 92 arranged outside the first and the second groups of memory slots 81 and 82. The row of fans 42 is juxtaposed to the circuit board 10. The longitudinal direction of the memory slots 81 and 82, and the expansion slots 91 and 92 is substantially perpendicular to the row of fans 42. In another embodiment, the first and the second groups of expansion slots 91 and 92 are appropriate for peripheral component interconnect express cards.

In other embodiments, the positions of the first group of memory slots 81, the second group of memory slots 82, and the CPUs 50 are adjustable according to need, but all are arranged on the side of the circuit board 10. Moreover, the number of the CPUs and the memory slots is variable according to need.

In use, airflow from the fan system 40 flows over and through the CPUs 50, the memory slots 81 and 82, and the expansion slots 91 and 92 substantially concurrently, thus no component which requires cooling will be exposed to pre-heated airflow.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such various modifications as are suited to the particular use contemplated.

Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A motherboard comprising:
a circuit board;
a first and a second groups of expansion slots mounted on a side of the circuit board;
a central processing unit (CPU) mounted between the first and the second groups of expansion slots; and
a group of memory slots mounted between the first and the second groups of expansion slots.

2. A server comprising:
a motherboard comprising:
a circuit board;
a first and a second groups of expansion slots mounted on a side of the circuit board;
a central processing unit (CPU) mounted between the first and the second groups of expansion slots; and
a group of memory slots mounted between the first and the second groups of expansion slots; and
a fan system arranged near the side of the circuit board, and comprising a plurality of fans arranged in a row extending along the side of the motherboard;
wherein the longitudinal direction of each of expansion slots is substantially perpendicular to the row of the fans.
